(19) United States
(12) Patent Application Publication
(10) Pub. No.: US 2006/0280392 A1
(43) Pub. Date: Dec. 14, 2006

(54) Bushing and rotation support device using the same

(75) Inventors: Katsuhisa Ishii, Okazaki (JP); Toshihiko Aoki, Anjo (JP); Takuya Ishii, Anjo (JP); Minoru Todo, Takahama (JP); Kazutoshi Nozaki, Togo (JP); Atsushi Honda, Seto (JP); Masafumi Kinoshita, Toyota (JP); Hirofumi Ota, Toyota (JP)

Correspondence Address: OLIFF & BERRIDGE, PLC, P.O. BOX 19928, ALEXANDRIA, VA, 22320, US

(73) Assignees: Aisin AW Co., Ltd., Anjo-shi (JP); Toyota Jidosha Kabushiki Kaisha, Toyota-shi (JP)

(21) Appl. No.: 11/436,624

(22) Filed: May 19, 2006

(30) Foreign Application Priority Data
May 20, 2005 (JP) 2005-148744
May 18, 2006 (WO) PCT/JP06/30997

(51) Int. Cl. F16C 33/10

(52) U.S. Cl. 384/286

(57) ABSTRACT

A lubrication groove is formed on a sliding face of a bushing, both ends of which open to the same end face of the bushing. The lubrication groove has inclined portions that extend from the openings in directions that approach each other, and a parallel portion that is in communication with the ends of the inclined portions via curved portions. Oil is guided to the lubrication groove so as to form an oil film on the sliding face. Sealability is achieved because the lubrication groove only opens to one end face of the bushing.

### CROSS-REFERENCE TO RELATED APPLICATION

The disclosures of Japanese Patent Application No. 2005-148744 filed on May 20, 2005, and PCT/JP2006/309970 filed on May 18, 2006, from which priorities are claimed, including the specification, drawings and abstract are incorporated herein by reference in its entirety.

### BACKGROUND

The disclosure relates to a bushing that supports a rotation member, and a rotation support device using the bushing. In particular, the disclosure is suitable for use in an automatic transmission, and more specifically relates to a bushing and a lubrication structure of the rotation support device.

In general, a bushing slidably supports a rotation member in a lubricated environment, and the bushing is often used as a rotation support device in a mechanical apparatus, such as an automatic transmission. A bushing used in a lubricated environment without forced lubrication may also be formed with a lubrication groove penetrating in an axial direction. For example, there is a bushing formed with a lubrication groove in communication with a pump unit side on an end of the bushing in the axial direction and with a seal chamber side on another end. Leakage oil from the pump unit is guided to the lubrication groove of the bushing, and further guided to the seal chamber while lubricating a space between the bushing and a drive shaft (see, for example, the related art described in Japanese Patent Application Publication No. JP-A-11-13670).

Alternatively, a hydraulic pump has been proposed where a bushing is formed with an oil groove instead of a lubrication groove, and the oil groove is in communication with a location on the pump unit side other than the bushing and with the seal chamber. Accordingly, hydraulic pressure on both ends of the bushing in the axial direction is increased, and oil is delivered from both ends of the bushing in the axial direction to a sliding face (see, for example, the invention described in Japanese Patent Application Publication No. JP-A-11-13670).

However, the bushing formed with the lubrication groove penetrating in the axial direction allows oil to flow from one end of the seal to the other. Consequently, the bushing does not form a seal, which makes it impossible to achieve a predetermined hydraulic pressure at one end of the bushing.

Furthermore, a bushing with a smooth sliding face (without a lubrication groove) requires an oil groove to be formed on a portion other than the bushing in order to increase hydraulic pressure at both ends of the bushing. Therefore, even if the bushing with a sealing member adhered to one end, was applicable to a hydraulic pump, such a bushing cannot be used in an automatic transmission because the other end of the bushing is not a sealing chamber. Furthermore, since oil is delivered from both ends of the bushing, oil cannot be adequately delivered to the sliding face of the bushing. Thus, requiring short divided bushing fragments to be placed at predetermined intervals in the axial direction.

### SUMMARY

The disclosure thus provides, among other things, a bushing formed with a lubrication groove and possessing adequate lubrication performance while also ensuring sealing performance, and a rotation support device using the bushing.

According to an exemplary aspect, a bushing supporting a rotation member has a lubrication groove whose ends open to an end face of the bushing. Therefore, oil guided to the lubrication groove forms an oil film between a sliding face of the bushing and the rotation member, such that the slide bearing function of the bushing can be maintained over a long period of time. Furthermore, the lubrication groove does not penetrate completely in the axial direction, thus assuring the sealing function of the bushing.

According to a second exemplary aspect, the lubrication groove has inclined portions that extend from both opening portions in directions that approach each other. Therefore, a flow of oil due to the rotation of the rotation member generates an oil flow inside the lubrication groove so as to supply a sufficient amount of oil to the sliding face. Consequently, highly precise rotation support with a low friction coefficient can be maintained over a long period of time.

According to a third exemplary aspect, at least two lubrication grooves are formed that open to different end faces of the bushing. Thus, regardless of which side the bushing is mounted from, for example, a right or left direction, at least one lubrication groove is capable of functioning. Consequently, the bushing can be easily mounted without concern for the direction in which the bushing is attached.

According to a fourth exemplary aspect, an end side in the axial direction of the bushing is a chamber filled with oil, and another side is an open space. Therefore, oil from the chamber passes through the lubrication groove and is supplied to the sliding face of the bearing. Consequently, highly precise rotation support can be maintained over a long period of time, and the sealing function of the bushing prevents the discharge of oil from the chamber to the open space.

According to a fifth exemplary aspect, the chamber is supplied with oil having a predetermined hydraulic pressure. Therefore, oil is supplied to the sliding face from an end face of the bushing, and the oil is also reliably guided to the lubrication groove so as to replenish the oil supplied to the sliding face. Consequently, an oil film can be reliably and uniformly formed on the sliding face of the bushing so as to achieve highly precise rotation support. In addition, the sealing function of the bushing ensures a predetermined hydraulic pressure in the chamber, and also enables the supply of oil from the chamber to other lubrication areas.

According to a sixth exemplary aspect, the chamber accumulates oil that has no hydraulic pressure. Therefore, oil in the chamber is guided and moves to the lubrication groove by a flow generated from rotation of the rotation member, whereby oil can be reliably supplied to the sliding face of the bushing. In addition, oil in the chamber does not flow out to the open space, so oil can be constantly retained inside the chamber to maintain highly precise rotation support.

### BRIEF DESCRIPTION OF THE DRAWINGS

The disclosure will be made with reference to the drawings, in which:

FIG. 1 is a skeleton diagram showing an automatic transmission;

FIG. 2 is an operation chart of the automatic transmission;

FIG. 3 is a speed diagram of the automatic transmission;

FIG. 4 is an enlarged cross-sectional view showing a part of the automatic transmission;

FIG. 5 is a developed view showing a bushing; and

FIG. 6 is a cross-sectional view of the bushing.

### DETAILED DESCRIPTION OF EMBODIMENTS

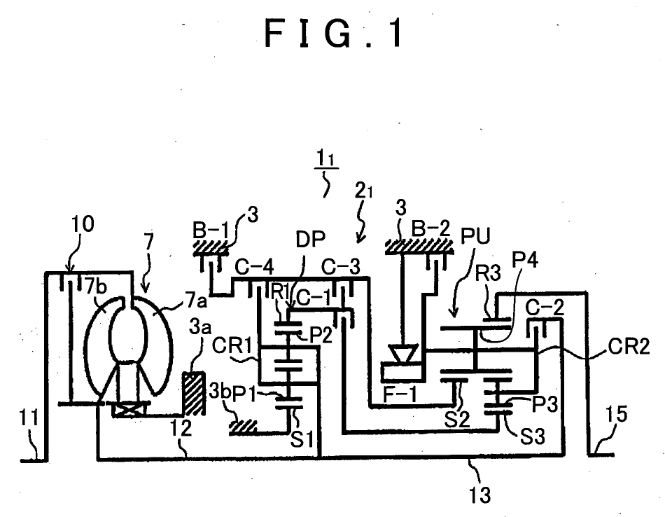

Hereinafter, an exemplary embodiment in which the disclosure is applied to an automatic transmission will be described with reference to the drawings. First, a schematic configuration of an automatic transmission 1₁ to which the disclosure can be applied will be described with reference to FIG. 1. The automatic transmission 1₁ may be one suitable for use in an FR-type (front engine, rear-wheel drive) vehicle. Provided in the automatic transmission 1₁ is an input shaft 1 capable of connecting to an engine (not shown). The automatic transmission 1₁ also has a speed change mechanism 2₁ and a torque converter 7 centered on the axial direction of the input shaft 11.

The torque converter 7 has a pump impeller 7a that is connected to the input shaft 11 of the automatic transmission 1₁, and a turbine runner 7b to which the rotation of the pump impeller 7a is transmitted via operation fluid. The turbine runner 7b is connected to an input shaft 12 of the speed change mechanism 2₁, with the input shaft 12 disposed on the same axis as the input shaft 11. Also provided in the torque converter 7 is a lock-up clutch 10, and when the lock-up clutch 10 is engaged through hydraulic control of a hydraulic control device (not shown), the rotation of the input shaft 11 of the automatic transmission 1₁ is directly transmitted to the input shaft 12 of the speed change mechanism 2₁.

The speed change mechanism 2₁ is provided with a planetary gear (a reduction planetary gear) DP, and a planetary gear unit (a planetary gear set) PU on the input shaft 12 (and an intermediate shaft 13 to be described in detail later). The planetary gear DP is a so-called double pinion planetary gear set, and has a sun gear S1, a carrier CR1, and a ring gear R1. The carrier CR1 has a pinion P1 that meshes with the sun gear S1, and a pinion P2 that meshes with the ring gear R1. The pinions P1 and P2 also mesh together.

The planetary gear unit PU is a so-called Ravigneaux planetary gear set, and has four rotation elements: a sun gear S2 (a first rotation element), a sun gear S3 (a second rotation element), a carrier CR2 (CR3) (a third rotation element), and a ring gear R3 (R2) (a fourth rotation element). The carrier CR2 has a long pinion P4 that meshes with the sun gear S2 and the ring gear R3, and a short pinion PS that meshes with the sun gear S3. The long pinion P4 and the short pinion PS also mesh together.

In the planetary gear DP, the sun gear S1 is held stationary and connected to a boss portion 3b that is integrally fixed to a transmission case 3 to be described in detail later. The carrier CR1 is connected to the input shaft 12 and has the same rotation as that of the input shaft 12 (hereinafter called “input rotation”). Also, the carrier CR1 is connected to a fourth clutch C-4 (an input transmission clutch). The ring gear R1 has a reduced rotation, the input rotation for which has been reduced by the stationary sun gear S1 and the carrier CR1, which provides the input rotation, i.e., which rotates together with the input shaft 12. Also, the ring gear R1 is connected to a first clutch C-1 (a reduced transmission clutch) and a third clutch C-3 (a reduced transmission clutch).

In the planetary gear unit PU, the sun gear S2 is connected to a first brake B-1, and fixable to the transmission case 3. Also, the sun gear S2 is connected to the fourth clutch C-4 and the third clutch C-3. The input rotation of the carrier CR1 is inputable to the sun gear S2 via the fourth clutch C-4, and the reduced rotation of the ring gear R1 is inputable to the sun gear S2 via the third clutch C-3. In addition, the sun gear S3 is connected to the first clutch C-1, and the reduced rotation of the ring gear R1 is inputable to the sun gear S3.

The carrier CR2 is connected to a second clutch C-2, to which the rotation of the input shaft 12 is input via the intermediate shaft 13, and the input rotation for the carrier CR2 is inputable via the second clutch C-2. Also, the carrier CR2 is connected to a one-way clutch F-1 and a second brake B-2. One direction of rotation of the carrier CR2 with respect to the transmission case 3 is controlled via the one-way clutch F-1, and the rotation of the carrier CR2 is fixable via the second brake B-2. The ring gear R3 is connected to an output shaft 15 that outputs rotation to a drive wheel (not shown).

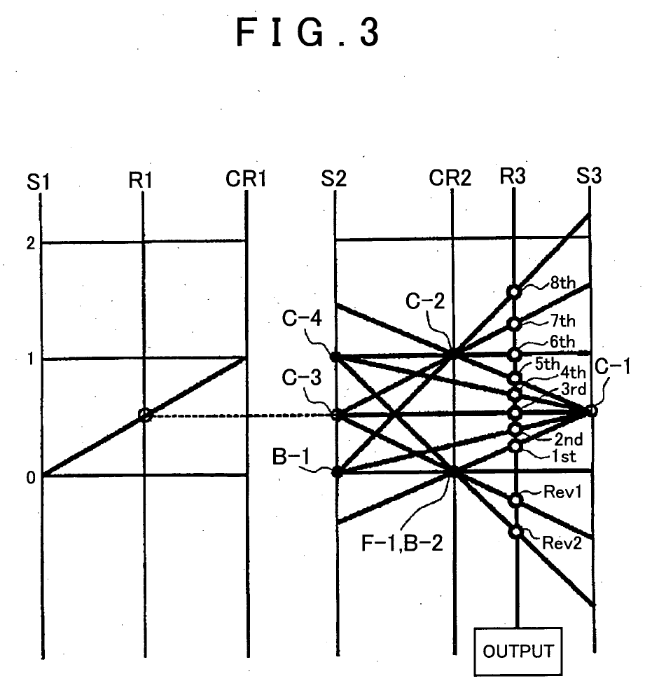

Based upon the configuration described above, the operation of the speed change mechanism 2₁ will be explained next with reference to FIGS. 1 to 3. Note that the vertical axis and horizontal axis of a speed diagram shown in FIG. 3 denote the rotational speeds of the rotation elements (gears), and the corresponding gear ratios of the rotation elements, respectively. For the planetary gear DP part of the speed diagram, an outermost vertical axis in the horizontal direction (a left side in FIG. 3) corresponds to the sun gear S1, and the remaining vertical axes toward the right side in the figure correspond to the ring gear R1 and the carrier CR1 in that order. For the planetary gear unit PU part of the speed diagram, an outermost vertical axis in the horizontal direction (a right side in FIG. 3) corresponds to the sun gear S3, and the remaining vertical axes toward the left side in the figure correspond to the ring gear R3, the carrier CR2, and the sun gear S2 in that order.

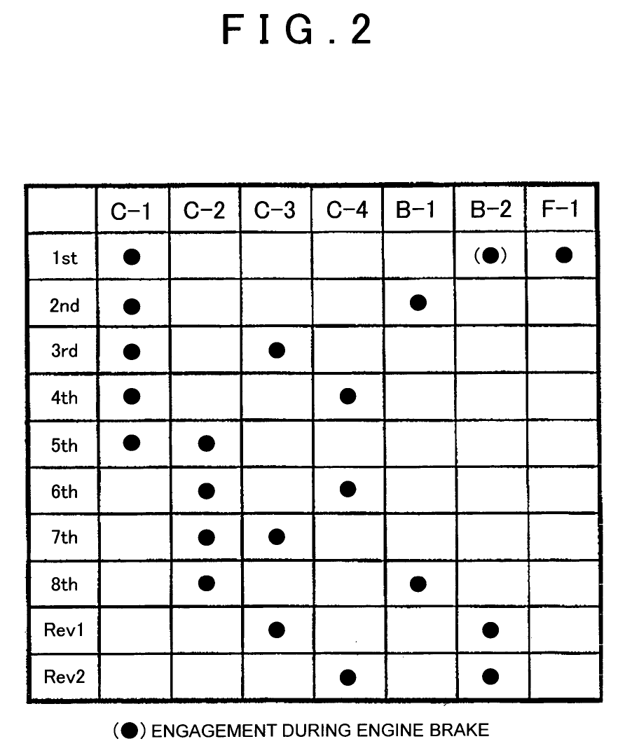

Regarding a D (drive) range, for instance, at a forward first speed (1st), the first clutch C-1 and the one-way clutch F-1 are engaged, as shown in FIG. 2. Accordingly, the rotation of the ring gear R1, which is reduced by the stationary sun gear S1 and the carrier CR1 that provides the input rotation, is input to the sun gear S3 via the first clutch C-1 as shown in FIGS. 1 and 3. The rotation of the carrier CR2 is also controlled in one direction (a direction of normal rotation), i.e., reverse rotation of the carrier CR2 is prevented and the carrier CR2 is held stationary. Accordingly, the reduced rotation input to the sun gear S3 is output to the ring gear R3 via the stationary carrier CR2. Normal rotation acting as the forward first speed is thus output from the output shaft 15.

Note that during times of engine braking (coasting), the second brake B-2 is engaged to hold the carrier CR2, so that the forward first speed is maintained while preventing normal rotation of the carrier CR2. At the forward first speed, reverse rotation of the carrier CR2 can also be prevented by the one-way clutch F-1 while allowing normal rotation. Therefore, the forward first speed can be smoothly achieved through automatic engagement of the one-way clutch F-1 when, for example, changing from a non-traveling range to a traveling range.

At a forward second speed (2nd), the first clutch C-1 is engaged and the first brake B- is held, as shown in FIG. 2. Accordingly, the rotation of the ring gear R1, which is reduced by the stationary sun gear S1 and the carrier CR1 that provides the input rotation, is input to the sun gear S3 via the first clutch C-1 as shown in FIGS. 1 and 3. The holding of the first brake B-1 also holds the sun gear S2 stationary. Accordingly, the carrier CR2 has a reduced rotation that is lower than the sun gear S3, and the reduced rotation input to the sun gear S3 is output to the ring gear R3 via the carrier CR2. Normal rotation acting as the forward second speed is thus output from the output shaft 15.

At a forward third speed (3rd), the first clutch C-1 and the third clutch C-3 are engaged, as shown in FIG. 2. Accordingly, the rotation of the ring gear R1, which is reduced by the stationary sun gear S1 and the carrier CR1 that provides the input rotation, is input to the sun gear S3 via the first clutch C-1 as shown in FIGS. 1 and 3. The reduced rotation of the ring gear R1 is also input to the sun gear S2 through engagement of the third clutch C-3. In other words, the reduced rotation of the ring gear R1 is input to both the sun gear S2 and the sun gear S3. Therefore, the planetary gear unit PU achieves a directly coupled state of reduced rotation, and the reduced rotation is output unchanged to the ring gear R3. Normal rotation acting as the forward third speed is thus output from the output shaft 15.

At a forward fourth speed (4th), the first clutch C-1 and the fourth clutch C-4 are engaged, as shown in FIG. 2. Accordingly, the rotation of the ring gear R1, which is reduced by the stationary sun gear S1 and the carrier CR1 that provides the input rotation, is input to the sun gear S3 via the first clutch C-1 as shown in FIGS. 1 and 3. The input rotation of the carrier CR1 is also input to the sun gear S2 through engagement of the fourth clutch C-4. Accordingly, the carrier CR2 achieves a reduced rotation that is faster than the sun gear S3, and the reduced rotation input to the sun gear S3 is output to the ring gear R3 via the carrier CR2. Normal rotation acting as the forward fourth speed is thus output from the output shaft 15.

At a forward fifth speed (5th), the first clutch C-1 and the second clutch C-2 are engaged, as shown in FIG. 2. Accordingly, the rotation of the ring gear R1, which is reduced by the stationary sun gear S1 and the carrier CR1 that provides the input rotation, is input to the sun gear S3 via the first clutch C-1 as shown in FIGS. 1 and 3. The input rotation is also input to the carrier CR2 through engagement of the second clutch C-2. Accordingly, a reduced rotation that is higher than the forward fourth speed is achieved due to the reduced rotation input to the sun gear S3 and the input rotation input to the carrier CR2, and is output to the ring gear R3. Normal rotation acting as the forward fifth speed is thus output from the output shaft 15.

At a forward sixth speed (6th), the second clutch C-2 and the fourth clutch C-4 are engaged, as shown in FIG. 2. Accordingly, the input rotation of the carrier CR1 is input to the sun gear S2 through engagement of the fourth clutch C-4. The input rotation of the carrier CR2 is also input via the second clutch C-2. In other words, input rotation is input to the sun gear S2 and the carrier CR2. Therefore, the planetary gear unit PU achieves a directly coupled state of input rotation, and the input rotation being output to the ring gear R3 is unchanged. Normal rotation acting as the forward sixth speed is thus output from the output shaft 15.

At a forward seventh speed (7th), the second clutch C-2 and the third clutch C-3 are engaged, as shown in FIG. 2. Accordingly, the rotation of the ring gear R1, which is reduced by the stationary sun gear S1 and the carrier CR1 that provides the input rotation, is input to the sun gear S2 via the third clutch C-3 as shown in FIGS. 1 and 3. The input rotation is also input to the carrier CR2 through engagement of the second clutch C-2. Accordingly, an accelerated rotation that is slightly higher than the input rotation is achieved due to the reduced rotation input to the sun gear S2 and the input rotation input to the carrier CR2, and is output to the ring gear R3. Normal rotation acting as the forward seventh speed is thus output from the output shaft 15.

At a forward eighth speed (8th), the second clutch C-2 is engaged and the first brake B-1 is held, as shown in FIG. 2. Accordingly, input rotation is input to the carrier CR2 through engagement of the second clutch C-2 as shown in FIGS. 1 and 3. The holding of the first brake B-1 also holds the sun gear S2 stationary. Accordingly, the input rotation of the carrier CR2 achieves an accelerated rotation that is higher than the forward seventh speed by the stationary sun gear S2, and the accelerated rotation is output to the ring gear R3. Normal rotation acting as the forward eighth speed is thus output from the output shaft 15.

At a reverse first speed (Rev1), the third clutch C-3 is engaged and the second brake B-2 is held, as shown in FIG. 2. Accordingly, the rotation of the ring gear R1, which is reduced by the stationary sun gear S1 and the carrier CR1 that provides the input rotation, is input to the sun gear S2 via the third clutch C-3 as shown in FIGS. 1 and 3. The holding of the second brake B-2 also holds the carrier CR2 stationary. Accordingly, the reduced rotation input to the sun gear S2 is output to the ring gear R3 via the stationary carrier CR2. Reverse rotation acting as the reverse first speed is thus output from the output shaft 15.

At a reverse second speed (Rev2), the fourth clutch C-4 is engaged and the second brake B-2 is held, as shown in FIG. 2. Accordingly, the input rotation of the carrier CR1 is input to the sun gear S2 through engagement of the fourth clutch C-4. The holding of the second brake B-2 also holds the carrier CR2 stationary. Accordingly, the input rotation input to the sun gear S2 is output to the ring gear R3 via the stationary carrier CR2. Reverse rotation acting as the reverse second speed is thus output from the output shaft 15.

Note that in a P (parking) and N (neutral) range, for example, the first clutch C-1, the second clutch C-2, the third clutch C-3, and the fourth clutch C-4 are all released. Accordingly, the connection between the carrier CR1 and the sun gear S2 is severed, as well as between the ring gear R1, the sun gear S2, and the sun gear S3. That is, the planetary gear DP and the planetary gear unit PU are disconnected. The connection between the input shaft 12 (intermediate shaft 13) and the carrier CR2 is also severed. Thus, the transmission of driving force between the input shaft 12 and the planetary gear unit PU is severed, i.e., there is no transmission of driving force from the input shaft 12 to the output shaft 15.

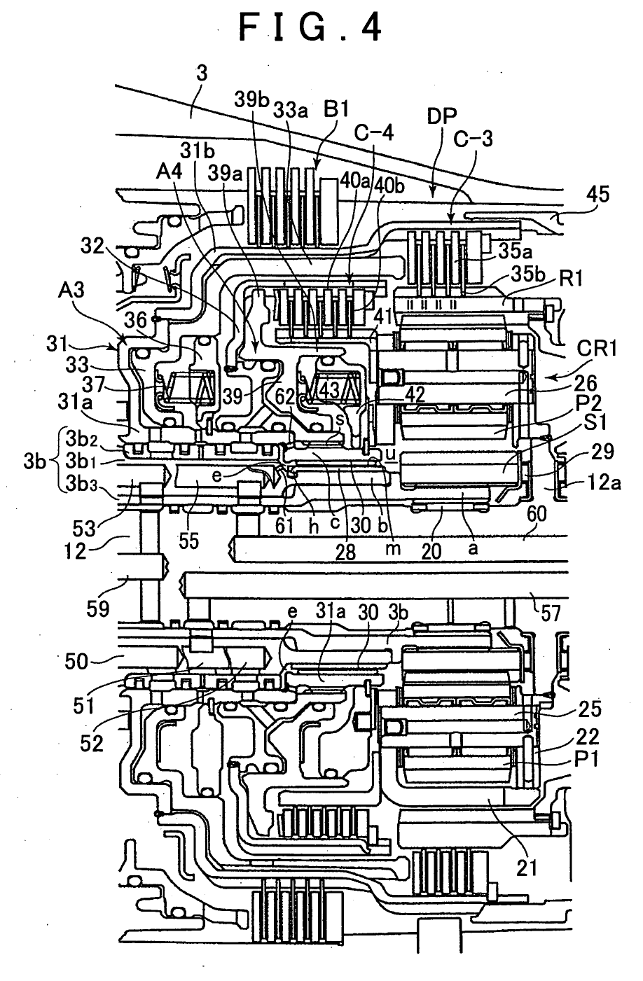

Next, the configuration of the planetary gear DP, which uses a bushing according to the disclosure, will be described in detail with reference to FIG. 4. The planetary gear DP is accommodated in the transmission case 3 along with the rest of the speed change mechanism 2₁. Extending from a pump cover integral with the transmission case 3 is a boss portion 3b thereof. In other words, the boss portion 3b structures a fixed member integral with the transmission case 3, and the fixed boss portion 3b is structured by a body 3b₁ that is integrally press fitted and fixed with an oil passage member 3b₂ on an outer peripheral face thereof, and a sleeve member 3b₃ on an inner peripheral face thereof. The sun gear S1 is in spline engagement with an outer periphery of an end portion of the boss portion 3b, and the input shaft 12 is rotatably supported on an inner periphery of the boss portion 3b via a bearing 20. The input shaft 12 is formed with a flange 12a that projects in the radial direction, and a flange 12b that is fixedly attached to the carrier CR1 by welding.

The carrier CR1 includes a carrier body 21 and a carrier cover 22. A plurality of pinion shafts 25, 26 with respectively different radii are supported across the body 21 ad the cover 22. Pinions P1, P2 are rotatably supported on the respective pinion shafts 25, 26 by needle bearings. Both the pinions P1, P2 mesh with each other, and the pinion P1 also meshes with the sun gear S1 while the pinion P2 meshes with the ring gear R1. Although not shown in FIG. 4, note that the ring gear R1 is connected to a clutch hub of the first clutch C-1 (see FIG. 1).

The boss portion 3b is structured with a plurality of steps on an end side thereof due to the existence of the oil passage member 3b₂ and the like. At a front-end minor diameter portion a, the sun gear S1 is in spline engagement. The sun gear S1 is positioned between steps of the boss portion 3b, with a thrust bearing 29 disposed between the sun gear S1 and the flange 12a. On an outer peripheral face of a medium diameter portion b of the boss potion, a C-3 clutch drum 31 is rotatably supported via a bushing 30 according to the disclosure. The clutch drum 31 is formed from the fixedly attached boss portion 31a and a drum portion 31b. An end portion of the boss portion 31a forms a stepped minor diameter portion c, and an inner peripheral face of the minor diameter portion c is pressed by the bushing 30. The bushing 30 slidably contacts a liner 28 fixed to the outer peripheral face of the medium diameter portion b of the boss portion 3b.

At an outer peripheral face of the clutch drum boss portion 31a, a C-4 clutch drum 32 is fitted therewith, and engagement is achieved by splines s at a minor diameter portion thereof so as to position and dispose the C-4 clutch drum 32 at a step. A front side of the clutch drum boss portion 31a (namely, a portion between the C-4 clutch drum 32 and a bottom portion of the clutch drum 31) is fitted with a C-4 piston 33 in a fluid-tight state so as to form a C-3 clutch hydraulic servo A3. The C-4 piston 33 has a rod 33a that is in spline engagement with the clutch drum portion 31b, and faces the third clutch C-3. The third clutch C-3 includes clutch plates (outer friction plates) 35a engaged with splines of the clutch drum portion 31b, and clutch discs (inner friction plates) 35b engaged with splines of an outer peripheral face of the ring gear R1. Furthermore, a circular plate 36 is disposed on a back face side of the C-4 piston 33 and positioned by the clutch drum boss portion 31a. A spring 37 is disposed between the plate 36 and a back face of the C-4 piston 33, and an outer peripheral face of the plate 36 is fitted in a fluid-tight state to structure an oil sac.

The C-4 clutch drum 32 is fitted with a piston 39 in a fluid-tight state so as to form a C-4 clutch hydraulic servo A4. The piston 39 also acts as a piston 39a that extends in an outer radial direction to achieve spline engagement with the clutch drum 32 and faces the fourth clutch C-4. The fourth clutch C-4 includes clutch plates (outer friction plates) 40a in spline engagement with the clutch drum 32, and clutch discs (inner friction plates) 40b engaged with a clutch hub 41 fixed to the carrier body 21. In addition, a circular plate 42 is disposed and held between the clutch drum boss portion 31a and a circular portion 39b that extends in the direction of the back face of the piston 39. A spring 43 is disposed between the plate and the back face of the piston 39, and an outer peripheral face of the plate 42 is fitted in a fluid-tight state to structure an oil sac. Note that the C-3 clutch drum 31 has an end engaged with a C-1 clutch drum 45.

The boss portion 3b is a fixed member and formed with a plurality of oil passages 50, 51, 52, 53, 55. The respective oil passages are supplied with predetermined hydraulic pressures from valve bodies. The oil passage 50 is in communication with the C-3 clutch hydraulic servo A3; the oil passage 51 is in communication with respective lubrication points via an oil passage 57 formed on the input shaft 12; the oil passage 52 is in communication with the C-4 clutch hydraulic servo A4; the oil passage 53 is in communication with the torque converter 7 via an oil passage 59 formed on the input shaft 12; and the oil passage 55 is in communication with a C-1 clutch hydraulic servo (not shown) via an oil passage 60 formed on the input shaft 12, and in communication with a chamber e on an end side of the bushing 30 via an orifice 61 formed on the boss portion 3b. Accordingly, an operation pressure of the oil passage 55 is reduced by the orifice 61 or the like to become a pressure corresponding to a lubrication pressure. Oil fills the chamber e, and is subsequently supplied to the bushing 30 from the chamber e, as well as supplied to the splines s via an oil gallery 62.

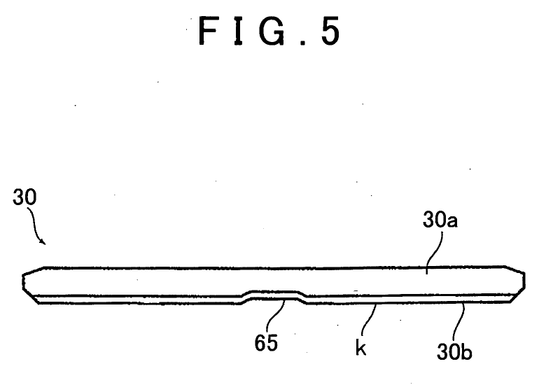

Regarding the bushing 30, as FIG. 5 shows, a back plate 30a made from a metallic material, such as, for example, steel, is sintered with an alloy, such as, for example, lead bronze. A sliding member 30b is fixedly attached to the back plate 30a, and saturated with lubrication oil or a low-friction resin, such as phenol or flourine, using the sintered portion as a matrix. An outer peripheral face of the back plate 30a is press fitted and fixed with an inner peripheral face (of the small diameter portion c) of the boss portion 31a of the clutch drum 31. The liner 28 is formed from a cylindrical member made of steel or the like, and is press fitted with the outer peripheral face (of the medium diameter portion b) of the boss portion 3b. A tab h formed on a portion of the liner 28 is engaged with a notch on the boss portion and fixed to the boss portion 3b. Furthermore, an inner peripheral face of the sliding member 30b of the bushing 30 slidably contacts an outer peripheral face of the liner 28 that is integrally fixed with the boss portion 3b so as to slide and support the clutch drum 31, which acts as a rotation member. Accordingly, the inner peripheral face of the sliding member 30b of the bushing 30 acts as a sliding face k, and the outer peripheral face of the liner 28 acts as a support face m that rotates relative to the sliding face k with an oil film disposed therebetween. Note that the bushing 30 is formed as a cylinder, but is not particularly limited by the above description. The bushing 30, for example, may be formed when embedded with a solid lubrication member, or formed using a ceramic, or formed from a solid. Other variations are also possible and may naturally be employed.

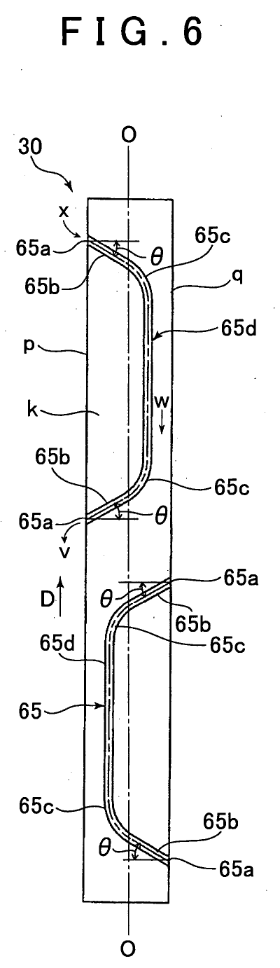

As FIG. 6 shows, the bushing 30 is formed with two lubrication grooves 65, 65 on the sliding member 30b, which is on the sliding face k side. Both end portions of one lubrication groove 65 open to an end face or side p in the axial direction of the bushing 30, forming opening portions 65a, 65a. One lubrication groove 65 also includes inclined portions 65b, 65b that extend from such opening portions 65a, 65a in directions that approach each other and pass over a centerline O-O in the bushing width direction at an identical predetermined inclination angle θ. Further included is a parallel portion 65d that connects both ends of the inclined portions 65b, 65b via predetermined curved portions 65c, 65c, and extends parallel to the bushing end face. The other lubrication groove 65 differs in that both end portions thereof open to another end face or side q in the axial direction of the bushing; however, the other lubrication groove 65 has an identical shape that includes the inclined portions 65b, 65b, the curved portions 65c, 65c, and the parallel portion 65d. In other words, the lubrication grooves 65, 65 have the same shape regardless of whether the bushing 30 is mounted or attached to face a right or left direction. Also note that the lubrication groove 65 is not particularly limited to the above shape, and may have inclined portions 65b, 65b whose angles are mutually different. Other shapes are also possible, such as one that does not include the curved portion 65c, one where the parallel portion 65d has a serpentine shape, or other shapes in which a groove width is modified as appropriate.

Next, operations according to the disclosure will be explained. An end p of the bushing 30 faces the chamber e, and the other end q faces an open space u where the planetary gear DP is positioned. The chamber e is filled with oil whose pressure has been reduced by passing from the oil passage 55 through the orifice 61. The oil is also guided to one lubrication groove 65 since the opening portions 65a, 65a open to the chamber e. An outer peripheral side of the chamber e faces the clutch drum boss portion 31a, which acts as a rotation element, and the bushing 30 that integrally rotates therewith. Due to rotation of the bushing 30 with boss portion 31a in a direction, such as shown by an arrow D in FIG. 6, the opening portion 65a and inclined portion 65b on the downstream side in the rotational direction D of the lubrication groove 65 have a shape that accepts the oil described above, and the other opening portion 65a and inclined portion 65b have a shape that discharges the oil following the rotational direction D. Therefore, as shown by an arrow x, oil within the chamber e is guided from one opening portion 65a to one inclined portion 65b of the lubrication groove 65, and further flows to one curved portion 65c and the parallel portion 65d, as shown by an arrow w. The oil subsequently passes through the other curved portion 65c and the other inclined portion 65b, and is discharged from the other opening portion 65a to inside the chamber e, as shown by an arrow v.

At the same time, the bushing 30 that is rotated with the clutch drum boss portion 31b rotates the sliding face k thereof in the direction of arrow D with respect to the liner 28 that acts as a fixed member. Therefore, oil inside the lubrication groove 65 opening to the sliding face k follows the rotation of the bushing 30 to generate a flow in the directions of arrows v, w, x. The influence of these flows thus generates an oil flow regardless of the lubrication groove 65 opening to the same end side p.

If a predetermined hydraulic pressure is supplied to the chamber e, oil is supplied from an end face p of the bushing 30 to the sliding face k. Furthermore, oil constantly fills the lubrication groove 65 so as to replenish oil supplied from the lubrication groove 65 to the sliding face k by rotation of the bushing 30 and the boss portion 31a, which acts as a rotation member.

Thus, the sliding face k of the bushing 30 is supplied with oil inside the chamber e from the end p, for instance, due to pressure corresponding to a lubrication oil pressure, and an oil flow is generated in the lubrication groove 65. Consequently, an appropriate oil film is constantly formed between the sliding face k of the bushing 30 and the outer peripheral face (support face m) of the liner 28, which acts as a fixed member. In this case, the parallel portion 65d of the lubrication groove 65 is positioned on a side opposite from the bushing width centerline O-O. Therefore, sufficient oil is supplied to a portion near the other end side q of the bushing 30, and also supplied from the chamber e to the end side p of the bushing, such that oil is uniformly supplied to the entire sliding face k of the bushing 30.

The chamber e may be maintained to a predetermined hydraulic pressure, since in addition to lubricating the bushing 30, oil must also be supplied to another lubrication area s via the oil gallery 62. Meanwhile, another end side of the bushing 30 forms the open space u. Thus, in order to maintain the chamber e to a predetermined hydraulic pressure, the bushing 30 must have a sealing function. The lubrication groove 65 is only in communication with one end face of the bushing 30, and it is therefore possible to ensure the formation of an oil film on the sliding face k by the lubrication groove 65 as explained above, without hydraulic pressure escaping from the lubrication groove 65. This characteristic can also improve the sealing function of the bushing 30. Thus, a bushing 30 with a predetermined length in the axial direction may be used.

At the first to fifth speeds, the C-3 clutch drum 31, which is a rotation member supported by the bushing 30, rotates with the third sun gear S3 due to a connection with the first clutch C-1. (The C-3 clutch drum 31 integrally rotates with the second sun gear S2 due to a connection with the third clutch C-3 at the third speed, and the fourth clutch C-4 at the fourth speed.) Furthermore, at the sixth speed, the C-3 clutch drum 31 rotates with the carrier CR1 and the second sun gear S2 due to the fourth clutch C-4. At the seventh speed, the C-3 clutch drum 31 rotates with the second sun gear S2 due to the third clutch C-3. The C-3 clutch drum 31 rotates with the second sun gear S2 via the third clutch C-3 at the reverse first speed, and rotates with second sun gear S2 via the fourth clutch C-4 at the reverse second speed. In other words, the clutch drum 31 acting as a rotation member rotates in accordance with many speeds, so sufficient oil must be constantly supplied to the bushing 30. At the first to fifth speeds, hydraulic pressure corresponding to a lubrication oil pressure is supplied via the orifice 61 to the chamber e from the oil passage 55 for supplying the hydraulic servo of the first clutch C-1. At the sixth and seventh speeds, the first clutch C-1 is released and no hydraulic pressure is supplied to the oil passage 55. Regardless of whether the oil inside the chamber e (and the oil inside the oil passage 55) have hydraulic pressure, the flow of oil inside the chamber e, and the like, is reliably guided inside the lubrication groove 65 and assures the formation of an appropriate lubrication film on the sliding face.

More specifically, at the first to fifth speeds, a predetermined hydraulic pressure is supplied to the chamber e. Thus, oil passes from an end face of the bushing 30 due to the hydraulic pressure and passes through the lubrication groove 65 so as to constantly replenish oil on the sliding face k. Meanwhile at the sixth and seventh speeds, the chamber e simply accumulates oil, and the oil in the chamber e has no hydraulic pressure. In this case as well, an oil flow generated by the rotation of the rotation member guides and moves oil to the lubrication groove 65 as explained above, such that an oil film is reliably formed on the sliding face k. At this time, oil in the lubrication groove 65, other than that forming the oil film above, is guided from one opening portion 65a and returns to the chamber e via the other opening portion 65a. Therefore, the amount of oil consumed in the chamber e is slight, while a supply of oil to the lubrication groove 65 is ensured.

Note that the bushing according to the disclosure is not particularly limited to supporting a rotation member of an automatic transmission as described in the above exemplary embodiments. The bushing according to the disclosure may also be similarly applied to supporting other rotation members of the automatic transmission, or supporting a rotation member in a mechanism other than an automatic transmission. Furthermore, the bushing 30 is not particularly limited to having two lubrication grooves 65, and three, four or more (preferably an even number of) grooves may be used. The use of only one lubrication groove 65 is also naturally possible as long as the direction of installation is prescribed. In the above exemplary embodiments, the bushing is fixed to a rotation member, and a sliding face of the bushing slidably contacts a fixed member. Alternatively, the bushing may be fixed to a fixed member and the sliding face of the bushing may slidably contact a rotation member. In such case, an outer peripheral face of the bushing 30 acts as the sliding face, and an inner peripheral face of the rotation member acts as the support face.

What is claimed is:

1. A bushing, comprising:
a sliding face that contacts a support face in relative rotation with an oil film disposed therebetween, wherein a lubrication groove is formed on the sliding face, and has a shape in which both ends of the lubrication groove open at positions separated by a predetermined distance on an end face in an axial direction of the bushing, and opening portions of both ends of the lubrication groove are in communication with each other.

2. The bushing according to claim 1, wherein the lubrication groove comprises:
inclined portions that incline from both the opening portions in directions that approach each other; and
a parallel portion in communication with end portions of both the inclined portions, and extends generally parallel to the end face of the bushing.

3. The bushing according to claim 2, wherein at least two lubrication grooves are formed, and both opening portions of one lubrication groove open to an end face of the bushing, and both opening portions of another lubrication groove open to another end face of the bushing.

4. A rotation support device, comprising:
a bushing according to claim 3, wherein:
the bushing is mounted between a rotation member and a fixed member such that the sliding face generates a rotation relative to the support face; and
an end side in the axial direction of the bushing is a chamber filled with oil, and another side is an open space.

5. The rotation support device according to claim 4, wherein the bushing is mounted between the fixed member and the rotation member such that the sliding face opposes a support face of the fixed member and a face opposite the sliding face is fixed to the rotation member.

6. The rotation support device according to claim 4, wherein the chamber is supplied with oil having a predetermined hydraulic pressure.

7. The rotation support device according to claim 4, wherein the chamber accumulates oil that has no hydraulic pressure.

8. A rotation support device, comprising:
a bushing according to claim 2, wherein:
the bushing is mounted between a rotation member and a fixed member such that the sliding face generates a rotation relative to the support face; and
an end side in the axial direction of the bushing is a chamber filled with oil, and another side is an open space.

9. The rotation support device according to claim 8, wherein the bushing is mounted between the fixed member and the rotation member such that the sliding face opposes a support face of the fixed member and a face opposite the sliding face is fixed to the rotation member.

10. The rotation support device according to claim 8, wherein the chamber is supplied with oil having a predetermined hydraulic pressure.

11. The rotation support device according to claim 8, wherein the chamber accumulates oil that has no hydraulic pressure.

12. The bushing according to claim 1, wherein at least two lubrication grooves are formed, and both opening portions of one lubrication groove open to an end face of the bushing, and both opening portions of another lubrication groove open to another end face of the bushing.

13. A rotation support device, comprising:
a bushing according to claim 12, wherein:
the bushing is mounted between a rotation member and a fixed member such that the sliding face generates a rotation relative to the support face; and
an end side in the axial direction of the bushing is a chamber filled with oil, and another side is an open space.

14. The rotation support device according to claim 13, wherein the bushing is mounted between the fixed member and the rotation member such that the sliding face opposes a support face of the fixed member and a face opposite the sliding face is fixed to the rotation member.

15. The rotation support device according to claim 13, wherein the chamber is supplied with oil having a predetermined hydraulic pressure.

16. The rotation support device according to claim 13, wherein the chamber accumulates oil that has no hydraulic pressure.

17. A rotation support device, comprising:
a bushing according to claim 1, wherein:
the bushing is mounted between a rotation member and a fixed member such that the sliding face generates a rotation relative to the support face; and
an end side in the axial direction of the bushing is a chamber filled with oil, and another side is an open space.

18. The rotation support device according to claim 17, wherein the bushing is mounted between the fixed member and the rotation member such that the sliding face opposes a support face of the fixed member and a face opposite the sliding face is fixed to the rotation member.

19. The rotation support device according to claim 17, wherein the chamber is supplied with oil having a predetermined hydraulic pressure.

20. The rotation support device according to claim 17, wherein the chamber accumulates oil that has no hydraulic pressure.
